(19) United States
(12) Patent Application Publication
(10) Pub. No.: US 2012/0270330 A1
(43) Pub. Date: Oct. 25, 2012

(54) Hybrid Separation and Detection Device for Chemical Detection and Analysis

(75) Inventors: Nongjian Tao, Scottsdale, AZ (US); Erica Forzani, Mesa, AZ (US); Rodrigo A Iglesias, Alto General Paz (AR); Francis Tsow, Tempe, AZ (US)

(73) Assignee: Arizona Board of Regents for and on behalf of Arizona State University, Scottsdale, AZ (US)

(21) Appl. No.: 13/395,625

(22) PCT Filed: Aug. 25, 2010
(86) PCT No.: PCT/US2010/046702

§ 371 Date: May 8, 2012

Related U.S. Application Data
(60) Provisional application No. 61/242,256, filed on Sep. 14, 2009.

(51) Int. Cl. G01N 30/02

(52) U.S. Cl. 436/140; 422/89

(57) ABSTRACT

The present invention provides a device that makes it possible to perform real-time detection and analysis of BTEX components in real samples using an inexpensive and miniaturized hybrid specific binding-separation device. The device may be used in occupational health and safety applications as well as for toxicological population studies to determine the presence of organic volatile components in an air sample.

### RELATED APPLICATIONS

This application hereby claims the benefit of prior filed co-pending U.S. provisional patent application No. 61/242,256, filed Sep. 14, 2009, of Tao et al., entitled “A HYBRID SEPARATION AND DETECTION DEVICE FOR CHEMICAL DETECTION AND ANALYSIS,” which is incorporated herein by this reference.

### FEDERALLY SPONSORED RESEARCH OR DEVELOPMENT

This research was funded in part by NIH/NIEHS (U01 ES0106064-01) via the GEI program awarded by the National Institutes of Health (NIH). The United States government has certain rights to this invention.

### BACKGROUND OF THE INVENTION

Detection and quantification of trace chemicals in air are basic and necessary requirements for many applications, including environmental, epidemiological, occupational safety and toxicological studies. In spite of recent advances, the tasks of analyzing multiple chemicals in a complex environment with thousands of interfering chemicals and substances, using a miniaturized and inexpensive device in real time, remains a difficult challenge.

A common strategy in sensor development is to rely on specific binding between a probe and a target molecule, or on molecular recognition. This strategy can lead to highly selective and sensitive detection of the analyte if the binding is strong and specific, but it has two inherent drawbacks. First, the strong binding results in slow recovery of the sensing elements, making it difficult for real-time monitoring of analytes with concentrations that vary with time. Second, this strategy cannot be applied to target analytes, such as aromatic hydrocarbons, that are weakly interactive and do not have a probe molecule to interact with.

A compromise strategy is based on pattern recognition, which uses an array of sensing elements. Another widely used strategy is separation-based techniques, including gas chromatography-mass spectrometry (GC-MS). Conventional GC-MS equipment is bulky, slow and expensive. Portable GC devices using different detectors^{1, 2, 3, 4, 5, 6, 7, 8, 9, 10} have been developed, but their sensitivity and selectivity are limited, cost is high, and physical size is still bulky for many applications.¹¹ As an effort to miniaturize GC, micromachined columns and preconcentrators have been investigated in combinations with SAW and chemresistor detectors.^{8, 12, 13} Pn-column micro GC with capillary-based ring resonators have also been developed.^{14, 15}

Thus, there remains a need for efficient devices that can be used for the analysis of air pollutants.

### BRIEF SUMMARY OF THE INVENTION

The present invention provides a device that makes it possible to perform real-time detection and analysis of BTEX components in real samples using an inexpensive and miniaturized hybrid specific binding-separation device. The device may be used in occupational health and safety applications as well as for toxicological population studies to determine the presence of organic volatile components in an air sample.

In exemplary embodiments, the present invention provides a device for the detection of chemical moieties in a gas sample, said device comprising (a) a flow control unit; (b) a separation unit; and (c) a detection unit comprising at least one sensor, such as resonating quartz crystal tuning fork, comprising a coating of a sensing material that specifically detects the presence of said chemical moieties in said gas sample; wherein said flow control unit is operably linked to and controls the flow of a mobile gas phase through the separation unit, said separation unit is operably linked to said detection unit and separates the components in said gas sample and provides said separated components to said detection unit; and said resonating tuning fork in said detection unit provides a signal to a high frequency resolution detection circuit that allows a qualitative and/or quantitative detection of said chemical moieties separated by said separation unit.

In specific embodiments, the flow control unit comprises a sample trap loop, a miniaturized valve for sample delivery to the device and a gas pump for introducing said mobile phase to said separation unit.

In specific embodiments the device is a hybrid device that includes a gas chromatograph as a separation unit and a specifically coated quartz crystal resonating tuning fork device as a detection unit. More specifically, the separation unit is a gas chromatography device coupled to a capillary gas chromatography column that is capable of separating volatile organic compounds. Preferably, the gas chromatography column is a two meter gas chromatography column comprised of carbowax and cyanopropylphenyl silicone capillary columns connected in series.

The device is preferably one in which the resonating quartz crystal tuning fork is coated with a highly cross-linked molecular imprinted polymer. The molecular imprinted polymer was prepared by either a polystyrene base cross-linked with divinylbenzene in the presence of the template of interest or just by polymerization of the cross-linking agent, i.e. divinylbenzene in the presence of the template. The template molecules are chosen based on the target analytes. For example, for BTEX detection, aromatic hydrocarbons are the choice target analytes, and xylenes mixture the preferred one target.

In one embodiment, the resonating quartz crystal tuning fork is coated with a highly cross-linked polystyrene with biphenyl imprints to create high density binding sites in the polystyrene for sensitive and selective detection of BTEX.

In other specific embodiments, the resonating quartz crystal tuning fork is coated with a highly cross-linked divynilbenzene matrix imprinted with molecules selected from the group consisting of benzene, toluene, ethylenebenzene, a xylene, a naphthalene and pyrene, or a polyaromatic hydrocarbon.

In other specific embodiments, the template molecule used to imprint the polymer is selected from the group consisting of benzene, toluene, ethylenebenzene, a xylene, a naphthalene and pyrene, or a polyaromatic hydrocarbon.

In specific embodiments, the tuning fork after coating has a resonance frequency of about 32 kHz. In the devices of the invention the tuning fork is connected to a high performance digital counter wherein said counter allows measurement of a resonance frequency of <2 mHz resolution, which resonance frequency allows detection of <4 pg/mm² substance weight. In specific embodiments, the high frequency resolution detection circuit comprises a chip to allow wireless capability.

It is contemplated that the detection unit comprises a plurality of resonating tuning forks, wherein different tuning forks comprising different coatings to selectively detect chemical moieties in said gas sample.

Specifically contemplated is a device that has at least one resonating quartz crystal tuning fork comprising a coating of a sensing material that allows the detection of one or more of benzene, toluene, ethylbenzene and xylenes in said gas sample. In other examples, the device further comprises a second resonating quartz crystal tuning fork comprising a coating of a sensing material that detects non-BTEX materials in said gas sample. The said coating comprises polycarbosilane derivative, polysiloxane derivative, fluoroalcohol polycarbosilanes, polycarbosilane polysiloxanes, and crown-ether derivatives.

The coating of the forks should be such that it does not impede the resonance of the forks. In exemplary embodiments, the coating comprises between 0.5-3 ug of coating material per tuning fork of a size of 250 μm×430 μm×3 mm.

In specific embodiments, the device is used to detect the presence of chemical moieties in air, and said chemical moieties are aromatic volatile organic compounds associated with traffic pollution.

In some embodiments, it is contemplated the device does not contain a column heating device for the chromatography columns and yet produces rapid separation of the VOCs. In other embodiments, the device further comprises a heating element to heat the chromatography columns.

Further embodiments contemplate devices that further comprise a sampling unit comprising a column packed with a material for the preconcentration of analytes prior to loading of said analytes to said separation unit. For example, such a preconcentration sample unit may comprise a column packed with a material selected from the group consisting of highly cross-linked polystyrene polymers, molecular sieves, carbopack X, carbopack B, carboxen and/or amorphous carbon materials or combinations thereof.

Other examples of the devices within the present invention are those that further comprise a zero filter for providing carrier gas to the separation device. Such a zero filter may be comprised of activated carbon, a molecular sieve, alumina, silica, activated carbon, graphite, polymers or a strong oxidizing material.

It should be understood that the devices of the present invention are to be used in the field and as such preferably are portable. More preferably, the device is a hand-held combined miniaturized gas-chromatograph and a detection apparatus comprising an array of quartz crystal tuning forks coated with molecularly imprinted polymers that specifically detect benzene, toluene, ethylbenzene and xylenes.

Also contemplated are methods of detecting the presence of benzene, toluene, ethylbenzene and xylenes in a gas sample comprising performing a miniaturized gas chromatographic separation of said sample and detecting the presence of BTEX therein using a device of the present invention. The method has a detection a lower detection limit of about 5 parts per million by volume (ppmV) and an upper detection limit of about 250 ppmV. Further the method is able to detect the presence of BTEX in a sample run time of from about 2 minutes to about 10 minutes.

### BRIEF DESCRIPTION OF SEVERAL VIEWS OF THE DRAWINGS

FIG. 1 Top: Schematic representation of the handheld sensing system for detection of BTEX. The system is formed by two main subsystems: a sensor array detector based on tuning fork resonators (TF) with tuned selectivity for detection of the analytes in complex environments, and a separation column subsystem. The system includes: (1) a miniature valve, (2) a mini gas pump, (3) and (4) bonded stainless steel capillary columns, and a novel detector formed by (5) a sensor chamber, array of polymer-modified tuning forks, and (6) a wireless high frequency resolution detection circuit. The inset at the bottom left shows a typical chromatogram of BTEX separation process corresponding to the injection of sub-nanomol amounts of analytes for 5 seconds.

FIG. 2. (A) Response of BP-MIP modified tuning fork to 40 ppmV toluene in air. Flow rate: 250 mL·min⁻¹. (B) Mass normalized response and reciprocal of response time for tuning forks modified with different polymers. Sample: 40 ppmV toluene. Flow rate: 250 mL·min⁻¹.

FIG. 3. Analysis of a BTEX mixture using the separation-TF detection system. Flow rate: 8 mL·min⁻¹. Injection time: 5 s. Gas carrier: clean air. Sample composition: 50 ppmV benzene, 50 ppmV toluene, 11 ppmV ethylbenzene, 29 ppmV m-xylene and 11 ppmV o-xylene.

FIG. 4. Response of 150 ppmV benzene after successive additions of different interferents to the same sample. (1) benzene, (2) acetone, (3) ethanol and (4) hexane. Exp. conditions are the same as in FIG. 3.

FIG. 5. Real sample analysis of a car's gas tank using the separation-TF system and conventional GC-MS with SPME preconcentration. (A) Dashed line: BTEX mixture (Sample composition: 50 ppmV benzene, 50 ppmV toluene, 11 ppmV ethylbenzene, 29 ppmV m-xylene and 11 ppmV o-xylene.), solid line car's gas tank sample. Flow rate: 8 mL·min⁻¹. Injection time: 5 s. (B) Correlation between the separation-TF detection system and the GC-MS method for a car's gas sample. Preconcentration on SPME fiber was performed for 5 minutes.

FIG. 6. (A) Comparison of responses given by the MIP-TF and SCF-TF sensors to different analytes. (B) Analysis of a car's gas sample using the separation-TF detection system with an array of polymer-modified tuning forks. Dash line: MIP-TF.

Solid line: SCF-TF.

FIG. 7. BTEX detection device. Top left corner: Picture of the hybrid separation—detection device. Remaining portion: Schematic of the core components of the system with insets of pictures of the columns (left) and detection, including the sensors and circuit (center) respectively, and BTEX chromatogram (right).

FIG. 8. Sensitivity of commercial and home-made synthesized materials towards toluene. The materials were cast on tuning fork sensors (TF). Sensitivity values were obtained from the TF response normalized by analyte concentration and coating mass (ppmV-1). Commercial polymers and synthesized materials were casted on the sensing surfaces of the tuning forks (TF) and their responses to several toxicant hydrocarbons (benzene (Ben), toluene (Tol), xylenes (EX), hexane (Hex), dodecane (Do), chloroform (Chl), trichloroethylene (TCE), perchloroethylene (PCE)) were studied. The synthesized materials included non-imprinted (NI) and molecularly imprinted (MIP) polymers based on polystyrene (PS) and polyurethane (PU), in the forms of uniform coating (c) or microparticle-coating (p). Several molecules were used as templates of MIPs (e.g.: Ben, Tol, biphenyl (BP) and pyrene (Pyr)). FIG. SI-1 summarizes the sensitivity of the most relevant results (toluene is used as example), showing that the MIPs-based on highly cross-liked polystyrene microparticles (HC-PSp) were the best.

FIG. 9. Sensitivity of BP-MIP vs. highly hydrophobic commercial material: Wax (residual polycyclic aromatic and long alkyl hydrocarbon mixture from petroleum distillation, Apiezon), Mineral Oil (alkyl hydrocarbon mixture with C=20-40, Aldrich), Ionic Liquid: 1-butyl-3-methylimidazolium hexafluorophosphate, linear polystyrene (Aldrich).

FIG. 10. Selectivity responses of BP-MIP towards xylenes (ethylbenzene, o,m,p-xylenes) and potential interference molecules. Excepting humidity, the analyte and interferent concentrations are 40 ppmV.

FIG. 11. Detection of BTEX in a separation-TF detection device. Separation performed in a packed column formed by silica particles. Column length: 10-15 cm, column diameter and material: ⅛″, Teflon tubing, flow rate: 72 mL/min (set on the pump before the column). Detection: BP-MIP modified TF sensor. Concentration of BTEX components: 4.2 ppmV each. Red curve: mixture of Benzene (Ben.) and Toluene (Tol.). Black curve: mixture of Benz., Tol., Ethylbenzene and Xylenes.

FIG. 12. Detection of 150 ppmV benzene in the presence of different concentrations of acetone in the same sample. Acetone concentrations: 0; 50; 100; 150; 200 and 250 ppmV

FIG. 13. GC-MS run of an air sample taken near the opening of a car's gas tank. The analysis was performed following a conventional method,^{1, 2} involving preconcentration of the sample in a poly(dimethylsiloxane) solid phase microextraction fiber (SPME) for 15 minutes, desorption of absorbed gases at 260° C. for 2 minutes, and separation for 12 minutes. The identified components in the sample are indicated. During the course of these experiments, clear advantages of our hybrid separation and detection device were observed over this GC-MS method when it comes to detectable toxicant levels (low ppmV). GC-MS method is not sensitive when solid phase microextraction fibers (SPME) are used with typical adsorption times of 15 min. We determined that in order to have a sensitive GC-MS analysis for low ppmV concentrations, adsorption times onto the SPME need to be ˜45 min. This demonstrates the superior performance of our sensor system

FIG. 14. Real sample analysis with hybrid separation and detection device. Separation using a silica packed column. Detection using a BP-MIP modified TF sensor. In FIG. 14A the curve labeled VOC from adhesive spray represents a real sample. In FIG. 14B the curve represents a BTEX sample. The real sample was collected in a laboratory during experimental activities with benzene, toluene and simultaneous remodeling activity requiring the use of an adhesive spray with 65% of VOCs content (Duro, All-purpose, Henkel Consumer Adhesives, Inc.). The chromatographic run clearly shows the BTEX components separated from other VOCs eluted at longer times. The BTEX components were estimated to be at ˜40 ppmV level. Inset: another sample run with the same system containing BTEX components and oxidation products of BTEX (by-products: carboxylic acid aromatic hydrocarbons). Again the BTEX components can be well separated from its carboxylic acid related derivatives.

### DETAILED DESCRIPTION OF THE INVENTION

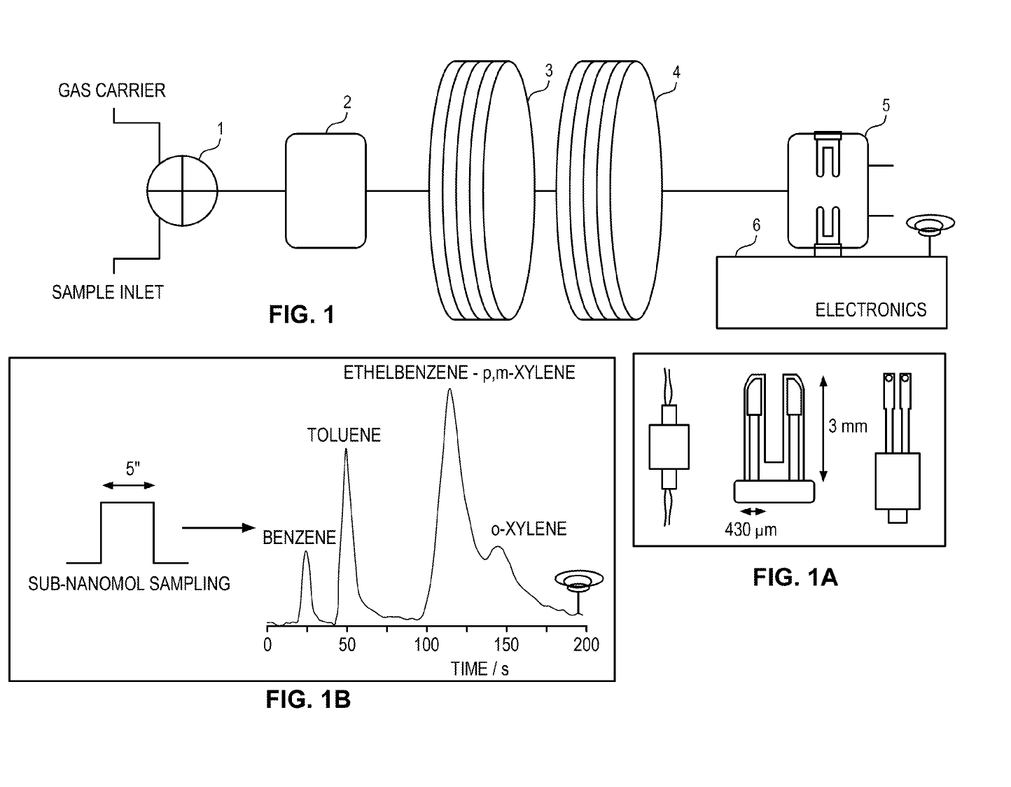

There is a need for sensitive perform real-time detection and analysis of BTEX components in real air samples that allows on-sight detection of these components in sampled air. In the present invention, there is described an inexpensive and miniaturized hybrid specific binding-separation device for achieving such detection. The invention combines and integrates two strategies, specific binding and chromatographic separation, synergistically into a miniaturized palm-size device that can quickly detect volatile organic compounds (VOCs) in complex environments (FIG. 1). Using the integrated device, the present inventors have been able to detect a few ppm-levels of Benzene, Toluene, Ethylbenzene and Xylenes (BTEX), the most common traffic related air pollutants, within 2-3 minutes, without the need of preconcentration. In addition, the device has wireless capability for instantaneous data transmission and remote control. The usefulness of the system is demonstrated with the analysis of BTEX content in real samples and validation of the results with a conventional GC-MS method.

As shown in FIG. 1, the device consists of three key components: (1) an injection unit consisting of a sample trap loop, a miniaturized valve and a gas pump capable of sampling and purging the system, (2) a separation unit using a set of one or several coupled capillary columns; and (3) a detector based on quartz crystal tuning forks. While all the components are important, the detector unit is particularly critical for the detection of BTEX.

The injection unit can contain one or several valves to control the injection from sampling or purging modes and set-up to redirect the sample directly into the separation unit, or to a sample trap loop, or into a predefined volume loop. The injection unit also includes one or two pumps working in pushing or pulling mode that can carry the gas carrier or gas sample through the different units composing the full system.

The sample trap loop of the injection unit consist of an inert tube, with optimized dimensions, containing one (one-stage trap) or several (multi-stage trap) absorbing/adsorbing materials that can be packed in beds separated by inert mesh stoppers.

The separation unit part of the device is a hand-held gas chromatograph that is fitted with capillary columns optimized to allow the gas chromatographic separation of the components of the samples. The coupled capillary column can have different lengths, internal diameters, inner thickness of the polymeric layer and inner materials chosen from the set of alkylpolysiloxanes, fluoroalkylpolysiloxanes, allylpolysiloxanes, cyanoalkyl- or cyanoallyl-polysiloxanes or polyethyleneglycol and its derivatives.

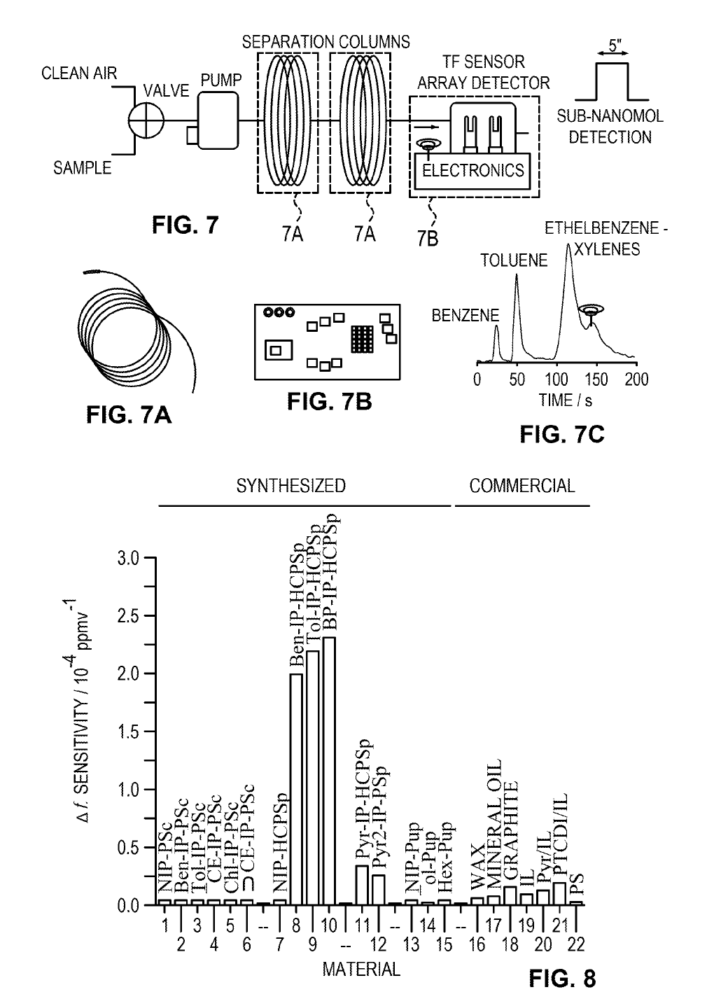

In specific embodiments, the GC is fitted with a tandem arrangement of two different columns coupled in series wherein one of the columns is based on poly(ethylene glycol) and the other is based on cyanopropylphenyl silicone. FIG. 7 shows how these columns may be arranged in series in the device. While these columns are provided as exemplary stationary phases for the GC columns, it should be understood that the GC may be fitted with any GC column that will provide the separation of organic volatile compounds.

The hybrid apparatus of the invention is one in which the separation unit (i.e., GC) is operatively linked to a detection system that is made of a sensing apparatus that contains microelectromechanical resonators linked to a high performance digital counter that detects the presence of the volatile organic compounds in the sample separated in the separation device by use of the signal produced by the microelectromechanical resonators as the VOCs come into contact with them.

The microelectromechanical resonators are quartz crystal resonator based tuning forks. Such quartz crystal resonating tuning forks are well known to those of skill in the art (see e.g., US Patent Publication 20080297008). Such tuning fork resonators work on the principle that where a tuning fork is oscillating at a resonant frequency, compounds present in the gas environment in which the forks are placed will collide with the tines of the tuning fork and cause a mechanical energy loss in the tines. This then creates a change in the resonant oscillation frequency of the fork with the frequency shift depending on the momentum that the tine imparts to the compounds in the gas.

In the present invention, the sensitivity of the tuning forks to BTEX is increased by modifying the tuning forks to give them a coating of an appropriate sensing material. For this purpose, a highly cross-linked polystyrene formed by divinylbenzene (Sigma), a high density of binding sites generated by the biphenyl (BP) (Sigma) template and the porogen solvent (ethylbenzene+o-,p-,m-xylenes)(Mallinckrod) gave the best performance. Synthesis of this polymer was performed according to the methods described by Lieberzeit et al. 2005.²⁷ Based on the chemical nature of the materials, the MIP binding sites bind to the target analytes primarily via multiple Π-Π and van der Waals interactions, which allows for selective but reversible binding. As the VOCs from the air bind to the tuning fork, the resonating frequency is altered and the presence of the VOCs is detected.

While in some embodiments, the device contains only tuning forks coated with materials that will specifically bind to one or more components of BTEX, in other embodiments, the sensitivity of the device can be improved by including tuning forks that are specifically coated with polymers that recognize non-BTEX molecules. In this regard, in one specific example, the tuning forks are coated with a fluoroalcohol polysiloxane polymer (SC-F201, Seacoast Science, Inc.) at a concentration of 20 mg·mL⁻¹ in toluene. This polymer is acidic and hydrophobic which can discriminate non-BTEX components. The use of multiple sensing elements with complementary functions improves the selectivity of the system, which is critical for real sample analysis. It is particularly contemplated that the device may contain 1, 2, 3, 4, 5, 6, 7, 8, 9, 10 or more tuning forks. Each tuning fork may be coated with a polymer that is derivatized to recognize only one component or it may recognize multiple components.

Molecularly imprinted polymers (MIPs) are synthetic materials with artificially generated recognition sites able to specifically rebind a target molecule in preference to other closely related compounds. In some approaches for preparing MIPs involve the formation of reversible covalent bonds between the template and monomers before polymerization. Then, the template is removed from the polymer by cleavage of the corresponding covalent bonds, which are re-formed when the polymer comes into contact with the analyte (e.g., benzene, toluene etc.) again. The high stability of template-monomer interaction leads to a rather homogenous population of binding sites, minimizing the existence of non-specific sites. An intermediate option is the semi-covalent approach in which the template is also covalently bound to a functional monomer, but the template rebinding is based only on non-covalent interactions and the formation of relatively weak non-covalent interactions (i.e. hydrogen bonding, ionic interactions) between template molecule and selected monomers before polymerization. This approach is by far the most used for the preparation of MIPs, mainly due to its experimental simplicity and to the commercial availability of different monomers able to interact with almost any kind of template. In this approach it is desirable to use a high amount of monomer material so that the excess of free monomers is randomly incorporated to the polymeric matrix leading to the formation of non-selective binding sites. A preferred method for use in the present invention for preparing MIPs is described in Reference 27.

In the present case, the target molecules would be molecules such as aromatic hydrocarbons such as benzene, toluene, ethylbenzene, xylenes, naphtalenes, pyrenes and the like. These molecules are mixed with the polystyrene polymers and once polymerization and cross-linking has occurred the target molecules are removed from the polymer leaving behind a “recognition site” for those molecules. The coating materials are typically made of polymers based on polystyrene (PS) or polyurethane (PU). The coating may be presented as a uniform coating on the sensing surface or alternatively may be in the form of a microparticle-coating. In specific examples described below, several molecules were used as templates of MIPs (e.g.: benzene, toluene, biphenyl (BP) and pyrene (Pyr)). FIG. 8 summarizes the sensitivity of the most relevant results (toluene is used as an example of the target molecule), showing that the MIPs-based on highly cross-liked polystyrene microparticles (HC-PSp) worked the best.

For one particular case, the molecular imprinted polymer for BTEX detection can be synthesized by a typical bulk polymer preparation scheme were the reaction mixture is maintained in a sealed deoxygenated vial at a temperature of 60-80° C. during 24-48 hours. The reaction mixture can be composed of different relationships of template, cross-linking agent, monomer and initiator. Particularly, for this example the template is xylenes, the cross-linking agent is divinylbenzene, the monomer could be styrene or low molecular weight polystyrene and the initiator is azobis-(isobutyronitrile); all of these compound in a relationship of 14:2:1:0.25 in weight or in a relationship of 14:2:0:0.25 to get a more compact structure. After the reaction ends the solid block of polymer is mesh to a dust-like powder and washed several times with few milliliters of xylenes. Finally, a mass of 2 mg of the polymer is suspended in a polystyrene/xylenes solution (2 mg in 1 mL) by sonication during three hours. This suspension is later used to cast or spin-coat the prongs of the tuning forks. Using the devices described herein the inventors were able to analyze samples of air for the presence of pollutants such as ethylbenzene, xylenes, naphtalenes, pyrenes. This work has successfully demonstrated that it is possible to perform real-time detection and analysis of BTEX components in real samples using an inexpensive and miniaturized hybrid specific binding-separation device. The system allows the detection and analysis of low ppmV detection of BTEX in complex samples within 3-4 minutes. The hybrid device is more selective than sensors based on specific binding only; and faster, simpler and more miniaturized than conventional portable GCs. It achieves the improved performance without pre-concentration, programmed heating elements and processes. The system is appropriate for occupational health and safety applications as well as for toxicological population studies.

These devices and the methods of use of the same are described in greater detail in the examples herein below.

### EXAMPLES

### Example 1

### Materials and Methods

Target Analytes:

BTEX is a group of aromatic volatile organic compounds (VOCs) associated with traffic pollution and represents more than 80% of automobile exhaust and other related traffic processes. Many epidemiological studies have associated BTEX to adverse effects in human health mainly on the nervous and hematopoietic systems with some incidence on cancer development.¹⁶ However, fundamental uncertainties persist due to the lack of appropriate tools for their detection and analysis in an efficient, fast, inexpensive, easy, and reliable way.

Quartz Crystal Tuning Forks (TFs) Sensors:

These are microelectromechanical resonators that provide intrinsic sensing properties, including low noise, low power consumption and high quality factor (˜10,000 in ambient air) associated to high sensitivity of mass or force (pN) detection (˜4 pg/mm²).¹⁷⁻¹⁹ The tuning forks have a resonance frequency of 32.768 kHz (Newark (none Electronics), a small size of 250 μm×430 μm×3 mm and an effective spring constant of 20 kN·m⁻¹. The thermal noise of the tuning fork is small with rms oscillation amplitude of 4×10⁻⁴ nm for the prongs at room temperature.^{17, 20, 21} A high performance digital counter was built which allows us to measure the resonance frequency with ˜2 mHz resolution, or equivalently 4 pg/mm² of mass detection limit. In addition, a Bluetooth chip connected to a microcontroller gives wireless capability to the detector. This enables transmission of data to other wireless-enabled systems, such as a computer or a cell phone, improving signal processing, storage and further transmission capabilities.

Sensing Materials Modifying the TF Sensors:

To obtain the desired selectivity²²⁻²⁶ for detection of BTEX components in complex environmental matrices, the tuning forks must be modified with appropriate sensing materials.

For this purpose, molecularly imprinted polymers (MIPs) were synthesized and screened to provide the needed selectivity as well as sensitivity, response time and reversibility (FIG. 8). A highly cross-linked polystyrene formed by divinylbenzene (Sigma), a high density of binding sites generated by the biphenyl (BP) (Sigma) template and the porogen solvent (ethylbenzene+o-,p-,m-xylenes)(Mallinckrod) gave the best performance. Synthesis of this polymer was performed according to Lieberzeit et al.²⁷ Based on the chemical nature of the materials, the MIP binding sites bind to the target analytes primarily via multiple Π-Π and van der Waals interactions, which allows for selective but reversible binding. A fluoroalcohol polysiloxane polymer (SC-F201, Seacoast Science, Inc.) at a concentration of 20 mg·mL⁻¹ in toluene was used to coat a second sensing element. The polymer is acidic and hydrophobic which can discriminate non-BTEX components. The use of multiple sensing elements with complementary functions improves the selectivity of the system, which is critical for real sample analysis.

The tuning forks were first coated with a hydrophobic layer by immersing them in toluene containing 10% (v/v) phenyltrimethoxysilane for 24 hrs. After rinsing the tuning forks with toluene and drying out with clean air, they were dipped 20 mM dodecanetiol in isopropanol for 60 minutes. In this way the quartz surface and also the electrodes of the tuning forks became hydrophobic. Subsequently the tuning forks were coated with BP-MIP (MIP-TF) and SC-F201 (SCF-TF) polymer. The masses of the polymer coatings ranged from 0.5-3 μg, and the sensitivities of the tuning forks vary within 20%.

Chromatographic Separation:

Gas samples were prepared by injecting microliter amounts of the liquid analyte into 40 L Tedlar bags filled with synthetic air (breathing quality) in order to get the desired concentration. Additional dilutions of samples were performed with a precision gas diluter or by mixing the contents of Tedlar bag with air, using an inert gas pump and timed valve switching. An inert gas pump provides a constant flow of air through a coupled stainless steel capillary column, made of two 2 meters long columns in series. The inner filling materials of the two columns are carbowax and cyanopropylphenylsilicone (Quadrex Inc.), respectively, to provide optimal separation performance. As best shown in FIG. 7, the outlet of the coupled capillary column was connected to a 50 μL chamber in which the tuning fork sensors are housed.

### Example 2

### Results and Discussion

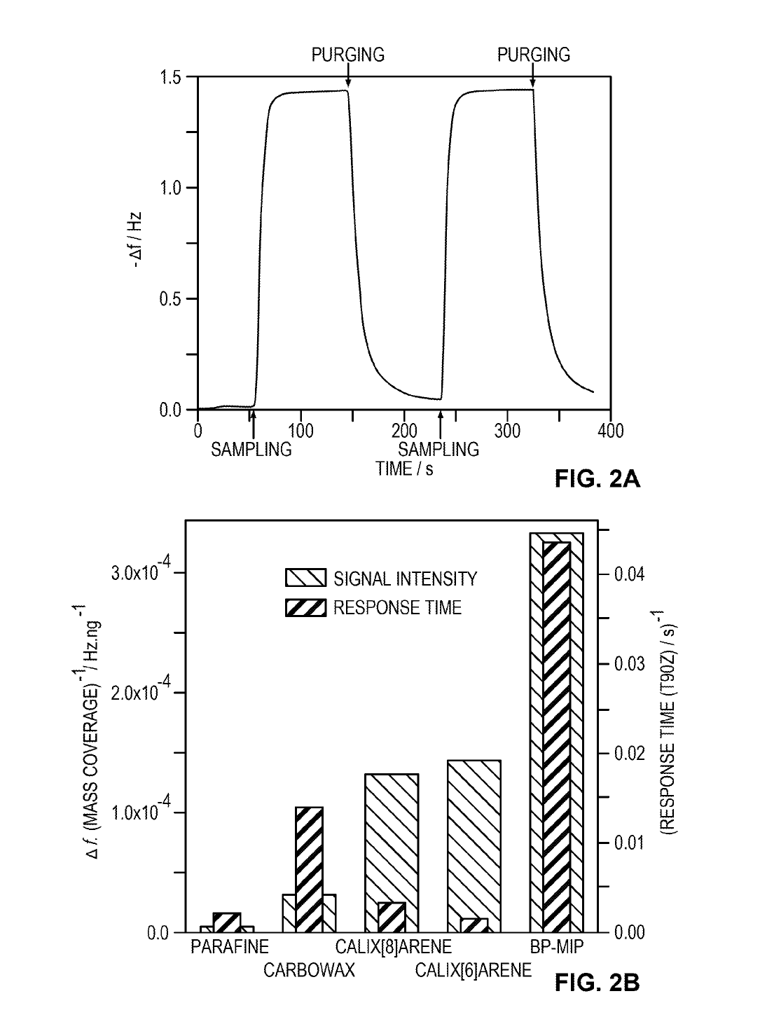

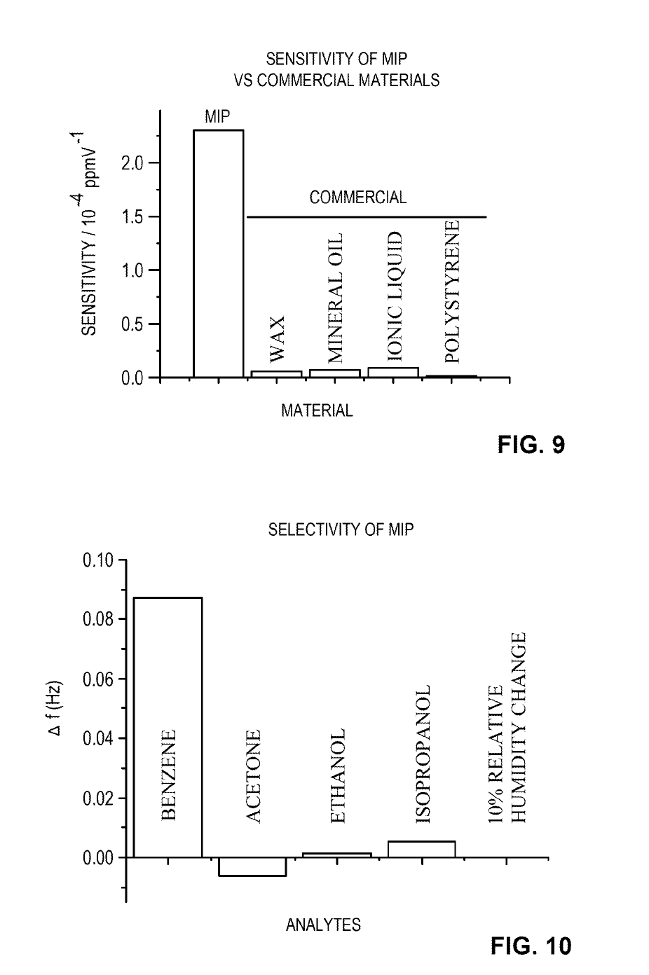

The detector was made of TFs coated with BP-MIP, and its response to toluene is shown in FIG. 2A. The response time taken at 90% of saturation response (T90) ranged from 15-25 seconds for sensors with typical mass coverage of 500-700 ng. More importantly, the BP-MIP-coated TFs showed a rapid desorption process, which is critical for real-time detection of analytes. Fast responses are also found for benzene and mixtures of ethylbenzene and xylenes. The superior performance of the BP-MIP-coated TFs is demonstrated by comparing them with commercial materials. FIG. 2B and FIG. 9 compares the response time and sensitivity of BP-MIP with commercial materials: (1) compact bulk polymers, such as Paraffin and Carbowax; and (2) compounds containing cavity structures, such as calixarenes, which have been used for the detection of analytes similar to BTEX, and (3) various hydrophobic materials. The BP-MIP synthesized in this work is superior for BTEX detection in terms of both response time and sensitivity. The detection limits of BP-MIP-modified TFs are several tens to a few hundreds ppbV (part per billion), which are suitable for occupational and industrial hygiene applications (Table 1, first and third entry column).

TABLE 1
Comparison between intrinsic detection limit of the M P-TF sensing,
element, separation-TF detecton device (Sep-TF) and Occupational, Safety
and Health Administration permisible exposure levels (OSHA PEL).
Detection limits

| | MIP-TF/ | GC-TF/ | OSHA PEL/ |
|---|---|---|---|
| | ppbV | ppmV | ppmV |
| Benzene | 700 | 10 | 10 |
| Toluene | 230 | 4 | 200 |
| p,m-Xylenes | 70 | 3 | 100 |

* Detection limits correlates with three times the noise level.
** OSHA PEL: OSHA Regulations. Standards 29CFR 1910.1000 TABLE Z-2

Although the detection limits of the MIP-TF sensing element are below 1 ppmV, it should be noted that the chromatographic separation, i.e. the Sep-TF detection, has detection limits of few ppmV levels. The difference is due to the flow rate dependence of the MIP-TF sensing element. Signal response for the MIP-TF sensor depends strongly on the sampling flow rate, reaching a steady state signal for flow rates higher than 100 ml·min⁻¹; however this high flow rate can not be reached with the chromatographic separation mainly because of two aspects: first one, the separation is not efficient at this high flow rate values and second one, such a big flow rates can not be reached with miniaturized gas pumps that are needed for a wearable device. The volume and geometry of the detection chamber that houses the tuning forks could also have an effect on the detection limits. We have examined the dead volume of the chamber, and found no obvious change in the detection limits for dead volumes varying from 50 to 500 μL.

Separation of BTEX

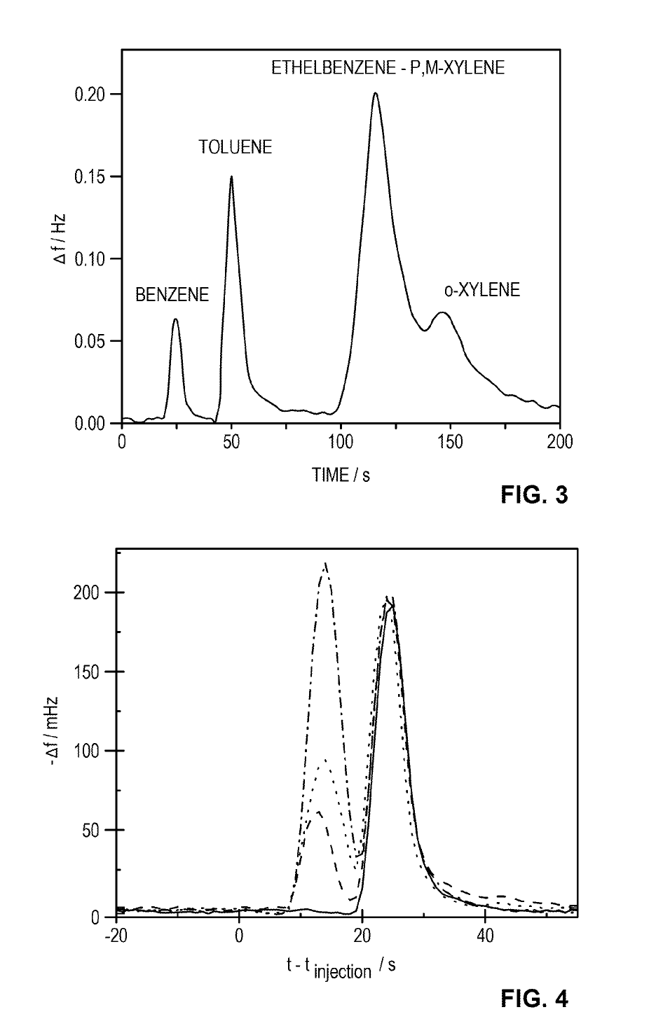

The selectivity of BP-MIP has been systematically tested using common interferents, such as alcohols, ketones and humidity (FIG. 10). Although BP-MIP provides selective detection of BTEX family, based on both different vapor pressures of the analytes²⁸ and partial specific binding of BP-MIP to BTEX, it is highly desirable to include additional mechanism to further improve the selectivity for real samples that contains many different interferent molecules. For this purpose, we have integrated the separation mechanism into the system. It is important to emphasize that we wish to achieve the hybrid device without compromising the simplicity and time response of the system. Unlike the conventional portable GC, we do not need to use preconcentrators owing to the high sensitivity of the TFs detector, which not only speeds up the detection time but also lower the cost, power consumption and reduces the size of the entire device. We do not heat the separation columns either, which is possible partially due to the selectivity of the sensing elements of the detector. In addition, instead of using a purified inert gas from cylinder as carrier gas, as is commonly done in conventional GC, we use ambient air passing through a simple filter. Finally, we further improve performance of the device by using short (2 meters) and optimized separation columns made of carbowax and cyanopropylphenyl silicone connected in series to achieve high run-speed without significantly lowering the separation capability. Using the integrated device, we are able to detect BTEX mixtures in less than 200 seconds with peak widths of 6, 7 and 15 seconds for benzene, toluene, ethylbenzene and xylenes, respectively (FIG. 3). It should be noted that under the developed experimental conditions it is not possible to separate ethylbenzene from m,p-xylenes because they have very close boiling points between 138-139° C.; however o-xylene with a boiling point of 144° C. can be resolved from the other ones. These lack of efficiency in the separation, also observed during GC-MS determinations, could be solved using flow restrictors at the middle point between the coupled capillary columns or using different compositions for the inner material of the capillary columns in order to get specific interactions that can differentiate between ethylbenzene and m,p-xylenes. Both of these later approaches are under development.

Several calibration tests indicate a linear dynamical range from ˜5 ppmV and up to 250 ppmV without hysteresis after the analysis of high concentrations. Beyond this, a stability test with the same sensing platform during seven months shows less than 5% of dispersion for BTEX detection; more than 200 tests with different concentrations were performed during this period of time.

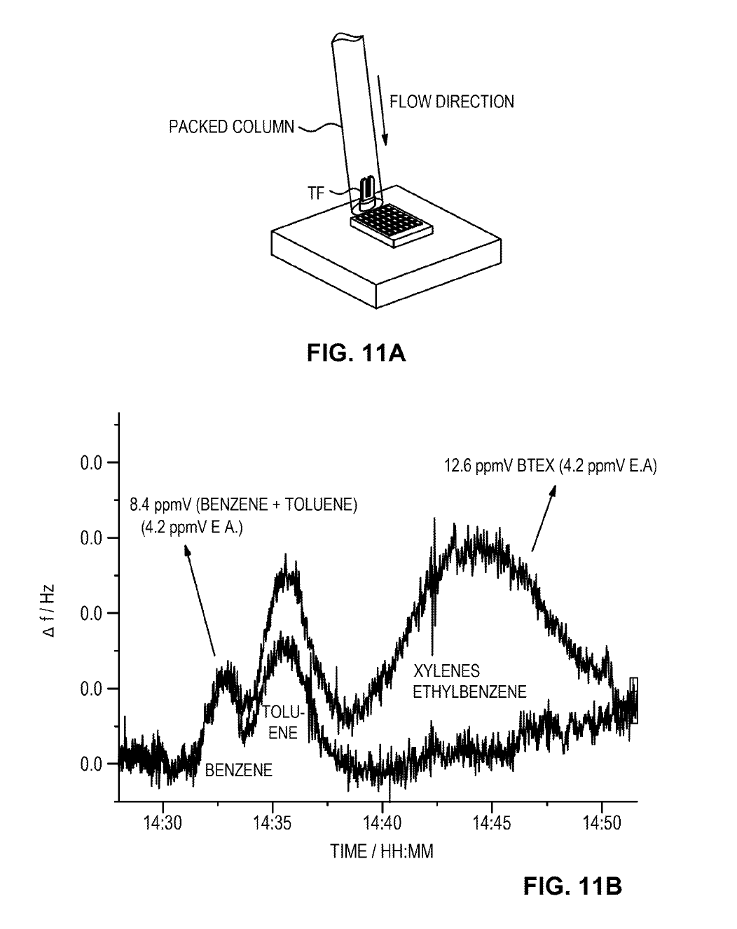

It is worthy to mention that columns based on silica particles packed in ⅛″ internal diameter Teflon tubing of ˜10-15 cm were also effective for separation of BTEX and offered an alternative for separation (FIG. 11). However, the separation time of BTEX components is longer (˜10 min), and for this reason we decided to keep the capillary columns.

Selective Detection of BTEX with the Hybrid Device.

In order to ensure a reliable analysis of BTEX mixtures without false positives or false negatives for real samples, we have tested the hybrid system using various interferents commonly found in ambient air. The selectivity coefficients, defined as the ratio of the response to each of the analytes to the interferents, range between 3-40 for common interferents, such as polar hydrocarbons, chlorinated hydrocarbons and some aliphatic hydrocarbons (Table 2). These selectivity coefficients were determined with samples having concentrations for the interferent at least three times higher than for the BTEX sample (BTEX sample: 40-50 ppmV; Interferent: 150 ppmV). We found good discrimination capability, due to the hybrid selective bind-separation approach. First, the BP-MIP TFs provide an intrinsic selective detection of benzene, toluene, and ethylbenzene & xylenes. Second, the separation mechanism allows us to separate analytes from the interferents in time domain and provide additional discrimination capability. FIG. 4 shows an example of detection of benzene in the presence of highly concentrated acetone, ethanol and hexane (total interferent concentration: 450 ppmV). It is clear that the benzene signal with an elution time of 24 s is not affected by the presence of the highly concentrated interferents and its signal is not changing when the concentration of interferent is varied.

TABLE 2
Estimated selectivity coefficients for detection of BTEX using the
separation-TF device
Estimated selectivity coefficients

| | Benzene | Toluene | Xylenes |
|---|---|---|---|
| Acetone | 33 | 75 | 115 |
| Ethanol | 42 | 95 | 146 |
| Dichloromethane | 4.2 | 21 | 28 |
| 1,3,S Trimethylbenzene | 8.9 | 39 | 155 |
| 1,2,4 Trichlorobenzene | 27 | 12 | 5.2 |
| Heptane | 1.8 | 32 | 212 |
| Cyclohexanone | 11 | 23 | 15 |
| Naphtalene | 4.6 | 24 | 231 |
| Dodecane | 66 | 150 | 240 |

* Estimated selectivity coefficients are the ratio of the signals between the analyte and the interferent. Signals were taken at the analyte elution time.

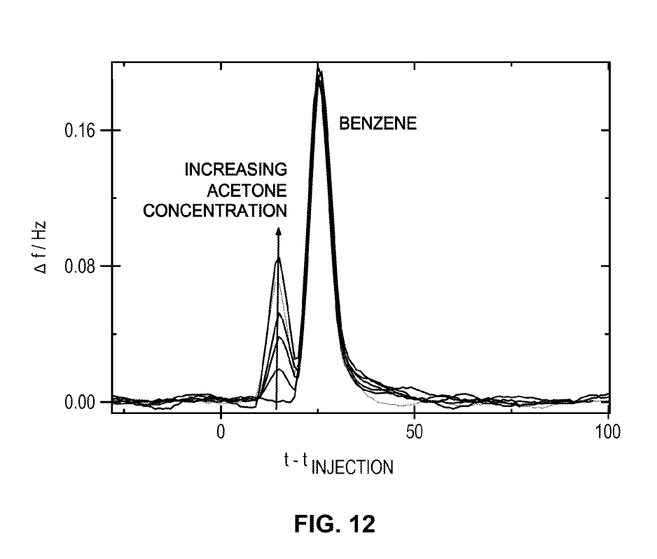

As a matter of fact, the signal for benzene at 150 ppmV does not depend on the concentration of acetone when this latter one is changing from 50 to 250 ppmV (FIG. 12); the same behavior is observed for different concentrations of ethanol or hexane. On the contrary, 1,2,4-trichlorobenzene and cyclohexanone at high concentrations influence the sensor selectivity (Table 2). They present broad peaks with elution times close to the elution time for xylenes, which reduce the selectivity coefficients xylenes/trichlorobenze and xylene/cyclohexanone down to 5.2 and 15.

Detection of BTEX in Real Samples

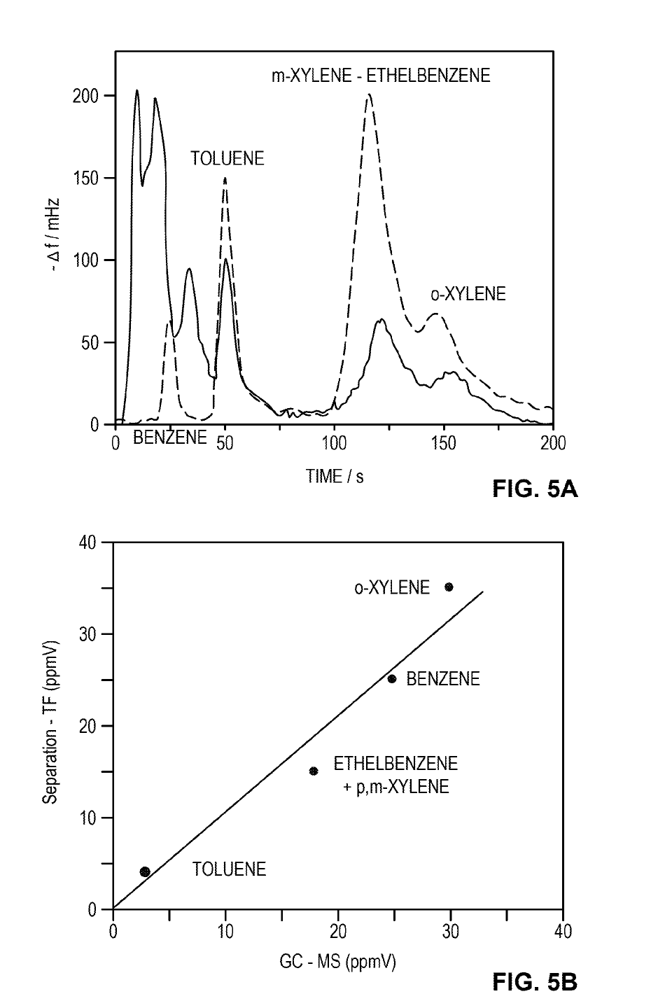

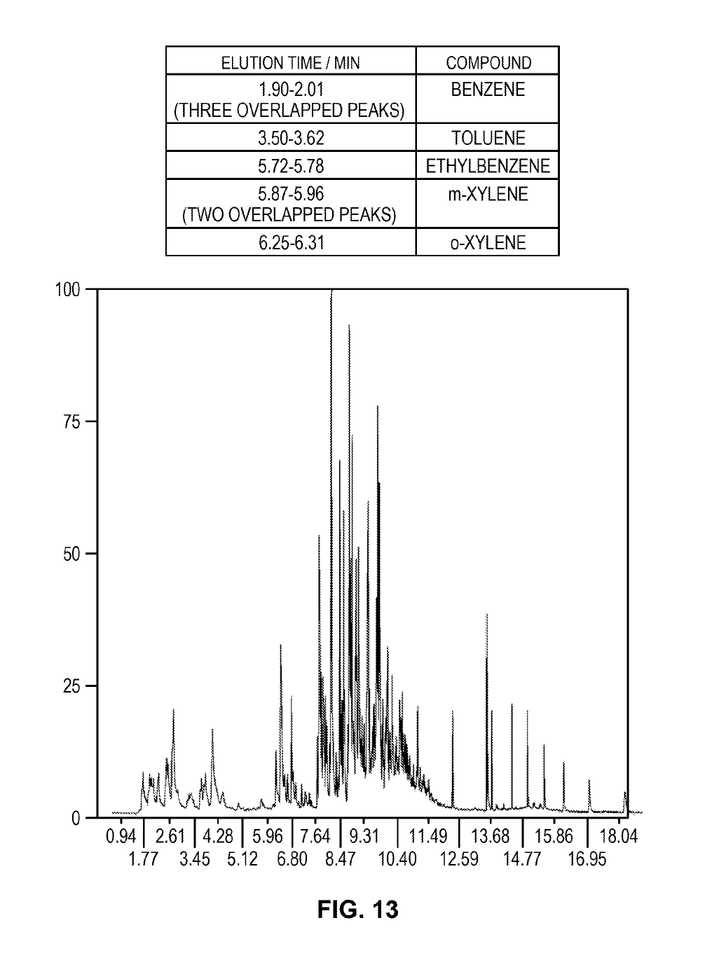

Gasoline vapors, one of the most complicate real samples,²⁹ were used to test the performance of the hybrid device. FIG. 5A compares the results of 50 ppmV BTEX mixture (dashed line) and air sample taken near the opening of a car's gas tank (solid line). Peaks corresponding to toluene (at 50 s) and ethylbenzene-xylenes (at 116 s) were well separated from the peaks arising from other components of the sample. However, at short elution times (less than 40 s), multiple peaks appeared corresponding to short hydrocarbons and other polar components at high concentrations in the sample (Supporting Information and next section). For comparison, we have carried out a similar analysis using a commercial GC-MS system. FIG. 5B shows that despite the simplicity of our system, the results are in good agreement with the reference GC-MS method with a correlation slope close to one (slope=1.05) and an average dispersion of less than 10%. We note that the GC-MS analysis requires 15-minute sample preconcentration in a poly(dimethylsiloxane) solid phase microextraction fiber (SPME) and another 12 min. run for the separation (FIG. 13). In contrast, our hybrid device does not need preconcentration, and the entire analysis is as short as 3-4 minutes. Furthermore, our system is palm size, which is critical for many field applications. Finally, we demonstrate below that the analytical capability of the system improves by including additional sensing elements functionalized with sensing materials with complementary chemical properties to BP-MIP.

Detector Based on Multiple Tuning Fork Sensors

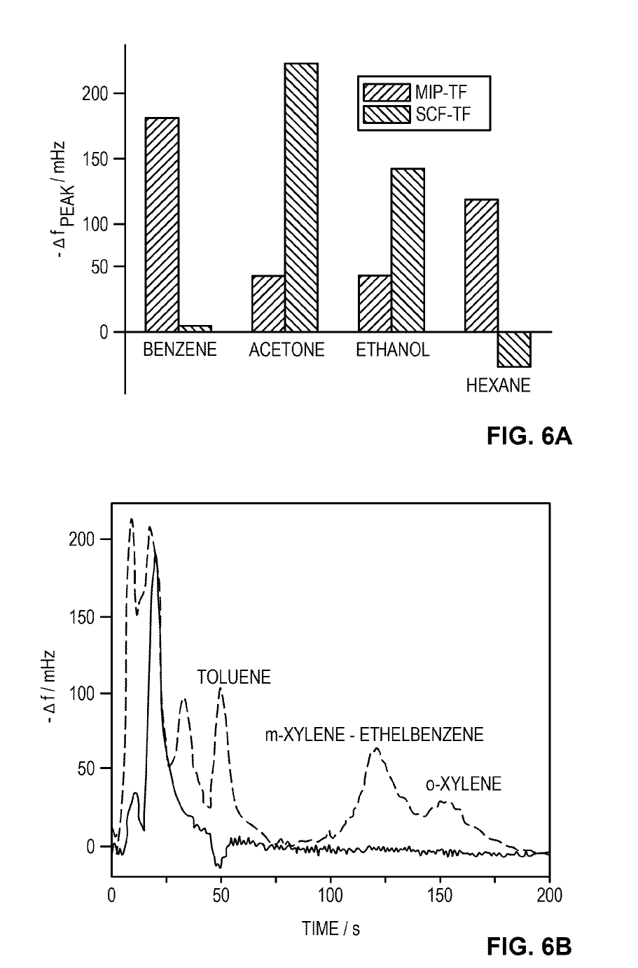

We have added another TF sensing element modified with fluoroalcohol polysiloxane (SCF-TF). In contrast to BP-MIP, SCF-TF is particularly selective and sensitive to polar VOCs, which is used to detect low molecular weight interferents at short elution times. FIG. 6A compares the responses obtained for different compounds using the BP-MIP-TF and the SCF-TF sensors. The SCF-TF sensor showed a large response to acetone and ethanol (polar VOCs) but negligible responses to benzene and other BTEX. Moreover it shows a positive shift in frequency in presence of hexane, probably due to a change in the stiffness constant of the coating.

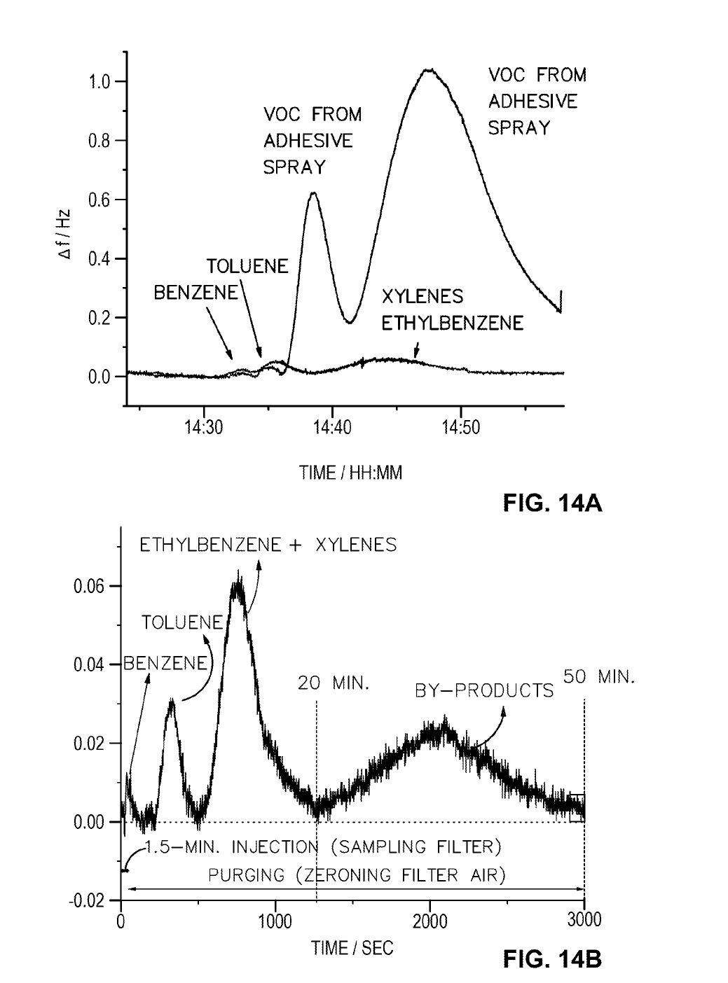

FIG. 6B depicts the analysis of the gasoline vapor sample with the hybrid device including the BP-MIP and SCF sensors. It shows that the MIP-TF sensor detects toluene, ethylbenzene and p,m,o-xylenes, but also some other compounds at short elution times. In contrast, the SCF-TF sensor does not detect BTEX components and detects only compounds eluting at short times (<50 s). By analyzing the relative responses of both sensing elements (FIG. 6A) and the run (FIG. 6B), it is possible to discriminate the composition of the sample in the region where peaks overlap for each of the sensing elements (t<50 s) and conclude that the compounds eluting at short times are mostly polar components and short alkyl hydrocarbons, which typically elute at short times (<40 s). We note that most real samples are not as complicated as gasoline vapors (see other example in Supporting information, FIG. 14) and both tuning fork sensors can work independently with good selectivity for BTEX mixture and also for polar components like acetone and ethanol. In most of the cases, it is possible to resolve a sample with different polar and BTEX components and BTEX concentrations equal or well below the Occupational Safety and Health Administration permissible exposure levels (Table 2, second entry column).

### REFERENCES

(1) www.agilent.com/chem/microgc.
(2) www.varianinc.com.
(3) www.hnu.com.
(4) www.photovac.com.
(5) http://microsensorsystems.com.
(6) http://www.raesystems.
(7) http://www.estcal.com.
(8) Elmi, I.; Zampolli, S.; Cozzani, E.; Mancarella, F.; Cardinali, G. C. Sensors And Actuators B-Chemical 2008, 135, 342-351.
(9) Kanda, K.; Maekawa, T. Sensors And Actuators B-Chemical 2005, 108, 97-101.
(10) http://www.torion.net/.
(11) http://www.raesystems.com/products/ultrarae-3000.
(12) Chia-Jung, L.; Steinecker, W. H.; Tian, W. C.; Oborny, M. C.; Nichols, J. M.; Agah, M.; Potkay, J. A.; Chan, H. K. L.; Driscoll, J.; Sacks, R. D.; Wise, K. D.; Pangad, S. W.; Zellers, E. T. Lab-on-a-chip 2005, 5, 1123-1131.
(13) Zampolli, S.; Elmi, I.; Sturmann, J.; Nicoletti, S.; Dori, L.; Cardinali, C. Sensors And Actuators B-Chemical 2005, 105, 400-406.
(14) Shopova, S. I.; White, I. M.; Sun, Y.; Zhu, H. Y.; Fan, X. D.; Frye-Mason, G.; Thompson, A.; Ja, S. J. Analytical Chemistry 2008, 80, 2232-2238.
(15) Sun, Y. Z.; Shopova, S. I.; Frye-Mason, G.; Fan, X. D. Optics Letters 2008, 33, 788-790.
(16) 2006, C. S. i. E. M. B. T. A. f. T. S. a. D. R. A. 2006.
(17) Ren, M. H.; Forzani, E. S.; Tao, N. J. Anal. Chem. 2005, 77, 2700-2707.
(18) Tsow, F.; Forzani, E. S.; Tao, N. J. Analytical Chemistry 2008, 80, 606-611.
(19) Ren, M. H.; Tsow, T.; Forzani, E. S.; Tao, N. J. Abstracts Of Papers Of The American Chemical Society 2005, 229, 396-ANYL.
(20) Tsow, F.; Tao, N. Applied Physics Letters 2007, 90.
(21) Boussaad, S.; Tao, N. J. Nano Lett. 2003, 3, 1173-1176.
(22) Fu, Y.; Finklea, H. O. Abstracts Of Papers Of The American Chemical Society 2003, 225, 133-ANYL.
(23) Dickert, F. L.; Tortschanoff, M.; Bulst, W. E.; Fischerauer, G. Analytical Chemistry 1999, 71, 4559-4563.
(24) Dickert, F. L.; Hayden, O. Advanced Materials 2000, 12, 311-314.
(25) Dickert, F. L.; Hayden, O. Trac-Trends In Analytical Chemistry 1999, 18, 192-199.
(26) Matsuguchi, M.; Uno, T. Sensors And Actuators B-Chemical 2006, 113, 94-99.
(27) Lieberzeit, P. A.; Gazda-Miarecka, S.; Halikias, K.; Schirk, C.; Kauling, J.; Dickert, F. L. Sensors and Actuators B: Chemical 2005, 111-112, 259.
(28) Grate, J. W.; Patrash, S. J.; Abraham, M. H. Analytical Chemistry 2002, 67, 2162.
(29) Sacks, R.; Klemp, M.; Akard, M. Field Analytical Chemistry And Technology 1996, 1, 97-102.

What is claimed is:

1. A device for the detection of chemical moieties in a gas sample, said device comprising:
a. a flow control unit;
b. a separation unit;
c. a detection unit comprising at least one sensor comprising a coating of a sensing material that specifically detects the presence of said chemical moieties in said gas sample;
wherein said flow control unit is operably linked to and controls the flow of a mobile gas phase through the separation unit;
said separation unit is operably linked to said detection unit and separates the components in said gas sample and provides said separated components to said detection unit; and
a sensor to provide a signal to a detection circuit that allows a qualitative and/or quantitative detection of said chemical moieties separated by said separation unit.

2. The device of claim 1, wherein said sensor is a resonating tuning fork that allows a qualitative and/or quantitative detection of said chemical moieties separated by said separation unit.

3. The device of claim 1, wherein said flow control unit comprises a sample trap loop, a miniaturized valve for sample delivery to the device and a gas pump for introducing said mobile phase to said separation unit.

4. The device of claim 1, wherein said separation unit is a capillary gas chromatography column.

5. The device of claim 1, wherein said sensing material, is a highly cross-linked polymer material imprinted with aromatic hydrocarbons.

6. The device of claim 5, wherein said highly cross-linked polymer material is based on cross linked divinylbenzene.

7. The device of claim 5, wherein said aromatic hydrocarbon is selected from the group consisting of benzene, toluene, ethylbenzene, biphenyl, naphthalene, pyrene, and a monoaromatic or polyaromatic hydrocarbon.

8. The device of claim 1, wherein said tuning fork has a resonance frequency of about 32 kHz.

9. The device of claim 1, wherein said tuning fork is connected to a high performance digital counter wherein said counter allows measurement of a resonance frequency resolution less than 2 mHz.

10. The device of claim 1, wherein said high frequency resolution detection circuit comprises a chip to allow wireless capability.

11. The device of claim 1, wherein said detection unit comprises a plurality of resonating tuning forks, wherein different tuning forks comprising different coatings to selectively detect chemical moieties in said gas sample.

12. The device of claim 1, wherein said at least one resonating quartz crystal tuning fork comprising a coating of at least one sensing material that allows the detection of one or more of benzene, toluene, ethylbenzene, xylenes (BTEX) or aromatic, alkyl or halogenated hydrocarbons in said gas sample.

13. The device of claim 12, wherein said device further comprises a second resonating quartz crystal tuning fork comprising a coating of a sensing material that detects non-BTEX materials in said gas sample.

14. The device of claim 11, wherein said device comprises a coating selected from a polyaromatic hydrocarbon, polycarbosilane derivative, polysiloxane derivative, fluoroalcohol polycarbosilanes, polycarbosilane polysiloxanes, crown-ether derivatives, and graphite derivatives, and combinations thereof.

15. The device of claim 4, wherein said gas chromatography column is a gas chromatography column comprised of carbowax and cyanopropylphenyl silicone capillary columns connected in series.

16. The device of claim 1, wherein said device detects the presence of chemical moieties in air, and said chemical moieties are aromatic volatile organic compounds associated with traffic pollution.

17. The device of claim 4, wherein said device does not contain a column heating device for the chromatography columns.

18. The device of claim 4, wherein said device further comprises a heating element to heat the chromatography columns.

19. The device of claim 1, wherein said device further comprises a sampling unit comprising a column packed with a material for the preconcentration of analytes prior to loading of said analytes to said separation unit.

20. The device of claim 19, wherein said column is packed with a material selected from the group consisting of a highly cross-linked polymer material imprinted with aromatic hydrocarbons, molecular sieves, carbopack X, carbopack B, carboxen and/or amorphous carbon materials or combinations thereof.

21. The device of claim 1, wherein said device further comprises a zero filter for providing carrier gas to the separation device.

22. The device of claim 21, wherein said zero filter is comprised of activated carbon, a molecular sieve, alumina, silica, activated carbon, graphite, polymers or a strong oxidizing material.

23. The device of claim 1, wherein said device is a hand-held combined miniaturized gas-chromatograph and a detection apparatus comprising an array of quartz crystal tuning forks coated with molecularly imprinted polymers that specifically detect benzene, toluene, ethylbenzene and xylenes.

24. A method of detecting the presence of benzene, toluene, ethylbenzene and xylenes in a gas sample comprising performing a miniaturized gas chromatographic separation of said sample and detecting the presence of BTEX therein using a device of any of claims 1-24.
